(19) United States
(12) Patent Application Publication
(10) Pub. No.: US 2023/0022397 A1
(43) Pub. Date: Jan. 26, 2023

(54) AIR QUALITY ADJUSTMENT SYSTEM

(71) Applicant: DAIKIN INDUSTRIES, LTD., Osaka (JP)

(72) Inventors: Takashi MAEDA, Osaka (JP); Shuji IKEGAMI, Osaka (JP); Shunji HARUNA, Osaka (JP)

(21) Appl. No.: 17/939,731

(22) Filed: Sep. 7, 2022

Related U.S. Application Data
(63) Continuation of application No. PCT/JP2021/010384, filed on Mar. 15, 2021.

(30) Foreign Application Priority Data
Mar. 31, 2020 (JP) 2020-062369

(51) Int. Cl. F24F 3/153; F24F 6/08

(52) U.S. Cl. CPC F24F 3/153; F24F 6/08; F24F 2110/10

(57) ABSTRACT

An air quality adjustment system includes an adsorption-desorption portion that adsorbs a target substance in air and desorbs the target substance adsorbed by the adsorption-desorption portion. The adsorption-desorption portion accumulates an energy in adsorbing the target substance and releases, in desorbing the target substance, at least part of the energy accumulated.

### CROSS-REFERENCE TO RELATED APPLICATIONS

This is a continuation of International Application No. PCT/JP2021/010384 filed on Mar. 15, 2021, which claims priority to Japanese Patent Application No. 2020-062369, filed on Mar. 31, 2020. The entire disclosures of these applications are incorporated by reference herein.

### BACKGROUND

### Technical Field

The present disclosure relates to an air quality adjustment system.

### Background Art

A humidity adjustment device has been known, which performs humidification and dehumidification of air by utilizing adsorption and desorption of moisture with an adsorbent.

Such a known humidity adjustment device is configured to perform the air dehumidification by causing the adsorbent to adsorb moisture in the air. The adsorbent in which the moisture is adsorbed is regenerated by heating, so that the adsorbing material can be reused for the dehumidification. In other words, the heating of the adsorbent causes desorption of the moisture from the adsorbing material, so as to regenerate the adsorbing material. On the other hand, the humidification is carried out by causing the adsorbing material to adsorb moisture in the air, desorbing the moisture from the adsorbent, and then supplying the moisture to air to be humidified. Again in this case, the desorption of the moisture from the adsorbent is carried out by heating the adsorbent. As an adsorbent, for example, zeolite, which has strong binding strength to water molecules and excellent moisture adsorption capacity, has been used.

### SUMMARY

A first aspect of the present disclosure is directed to an air quality adjustment system, including an adsorption-desorption portion configured to adsorb a target substance in air and desorb the target substance adsorbed by the adsorption-desorption portion. The adsorption-desorption portion is configured to accumulate an energy in adsorbing the target substance and release, in desorbing the target substance, at least part of the energy accumulated.

### BRIEF DESCRIPTION OF THE DRAWINGS

FIG. 1 is an overall schematic diagram of an air quality adjustment system according to a first embodiment.

FIG. 2 is a schematic diagram illustrating part of the air quality adjustment system according to the first embodiment

FIG. 3 is a view illustrating properties of an adsorbent used in the first embodiment.

FIG. 4 illustrates one example of movements on a psychrometric chart for the case where dehumidification is carried out with the adsorbent used in the first embodiment.

FIG. 5 illustrates one example of movements on a psychrometric chart for the case where humidification is carried out with the adsorbent used in the first embodiment.

FIG. 6 is a view illustrating a residual energy of a target substance in the case of adsorbing the target substance to the adsorbent.

FIG. 7 is a schematic view illustrating an air state in the case of adsorbing the target substance to the adsorbent used in the first embodiment.

FIG. 8 is a schematic view illustrating an air state in the case of desorbing the target substance from the adsorbent used in the first embodiment.

FIG. 9 is a schematic configuration diagram illustrating part of an air quality adjustment system according to a variation of the first embodiment

FIG. 10 is a schematic cross-sectional view of a building with an air quality adjustment system according to a second embodiment implemented.

FIG. 11 shows a plan view, a right-side view, and a left-side view schematically illustrating a configuration of the air quality adjustment system according to the second embodiment

FIGS. 12A and 12B are piping system diagrams illustrating a refrigerant circuit of the air quality adjustment system according to the second embodiment. FIG. 12A illustrates a flow of a refrigerant flows during a first operation, and FIG. 12B illustrates a flow of a refrigerant flows during a second operation.

FIG. 13 is a block diagram illustrating a configuration of a controller of the air quality adjustment system according to the second embodiment.

FIG. 14 shows a plan view, a right-side view, and a left-side view schematically illustrating how the air flows in the first operation of a dehumidifying operation of the air quality adjustment system according to the second embodiment.

FIG. 15 shows a plan view, a right-side view, and a left-side view schematically illustrating how the air flows in the second operation of the dehumidifying operation of the air quality adjustment system according to the second embodiment.

FIG. 16 shows a plan view, a right-side view, and a left-side view schematically illustrating; how the air flows in the first operation of a humidifying operation of the air quality adjustment system according to the second embodiment.

FIG. 17 shows a plan view, a right-side view, and a left-side view schematically illustrating how the air flows in the second operation of the humidifying operation of the air quality adjustment system according to the second embodiment.

### DETAILED DESCRIPTION OF EMBODIMENT(S)

### First Embodiment

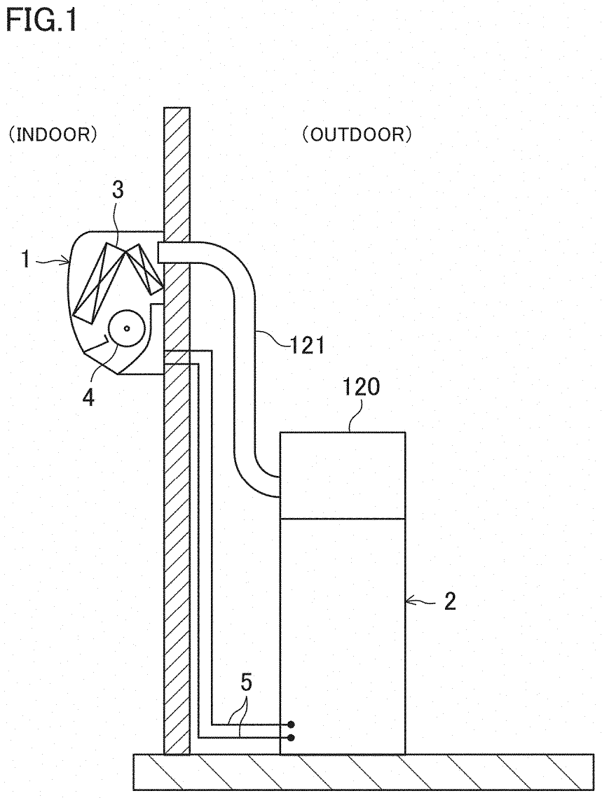

A first embodiment will be described below with reference to the drawings. As illustrated in FIG. 1, an air quality adjustment system according to the present embodiment is a humidity adjustment device integrated with an air conditioner and configured to perform humidification.

The air quality adjustment system as illustrated in FIG. 1 includes an indoor unit (1) and an outdoor unit (2). The indoor unit (1) includes an indoor heat exchanger (3) and an indoor fan (4) and is installed on an indoor wall. The outdoor unit (2) is installed outdoors. Although not shown, the outdoor unit (2) includes components such as a compressor, an expansion mechanism, an outdoor heat exchanger, and an outdoor fan. The indoor unit (I) and the outdoor unit (2) are connected via a pair of connection pipes (5).

A refrigerant circuit is formed by connecting the indoor heat exchanger (3) with the compressor, the expansion mechanism, and the outdoor heat exchanger via the connection pipes (5) and the like. The refrigerant circuit includes a four-way switching valve (not illustrated), so that a direction of circulation of the refrigerant can be reversed. Furthermore, the refrigerant circuit switches over a refrigeration cycle operation and a heat pump operation with the refrigerant circulating.

A humidifying unit (120) is a component of the humidity adjustment device according to this embodiment and is integrated with the outdoor unit (2). The humidifying unit (120) is connected with one end of an air duct (121). The other end of the air duct (121) is connected with the indoor unit (1). More specifically, the other end of the air duct (121) is open upstream of the indoor heat exchanger (3) inside the indoor unit (1).

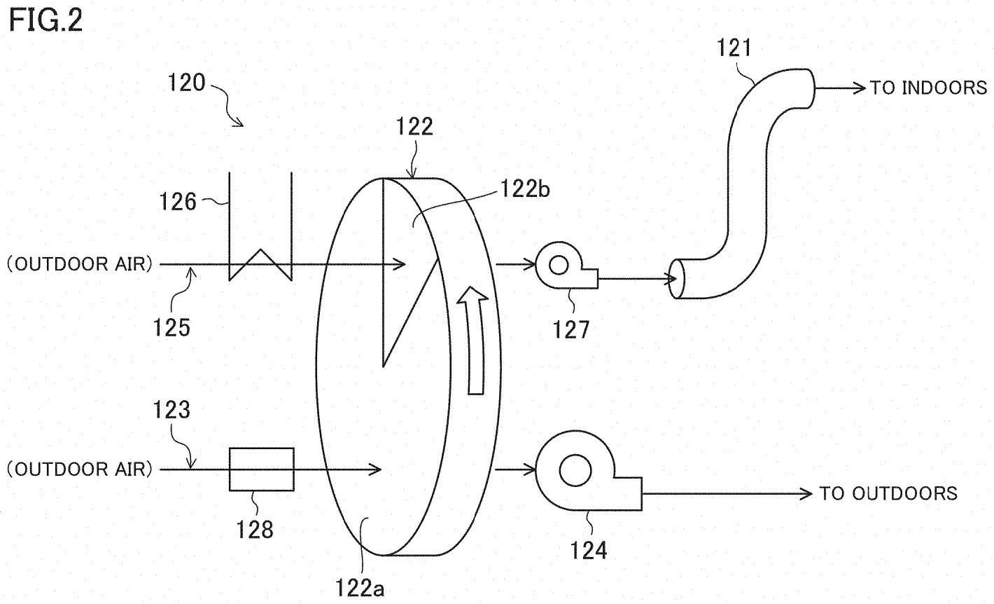

As illustrated in FIG. 2, the humidifying unit (120) is such that a dehumidification path (123) and a regeneration path (125) are defined. Moreover, the humidifying unit (120) includes a rotation rotor (122) in such a posture that the rotation rotor (122) is positioned across both the dehumidification path (123) and the regeneration path (125). The rotation rotor (122) functions as an “adsorption/desorption portion” in the present embodiment.

A dehumidification-side fan (124) is provided downstream of the rotation rotor (122) in the dehumidification path (123). As a result of operation of the dehumidification-side fan (124), outdoor air is taken into the dehumidification path (123). The outdoor air thus taken into the dehumidification path (123) is exhausted outdoors after passing the rotation rotor (122). A cooling portion (128) configured to cool the air before entering the rotation rotor (122) may be provided upstream of the rotation rotor (122) in the dehumidification path (123).

In the regeneration path (125), a heater (126) serving as a “heating portion” and a regeneration-side fan (127) are provided. Moreover, a terminal of the regeneration path (125) is connected with the one end of the air duct (121), The heater (126) is provided upstream of the rotation rotor (122) so as to heat the air before entering the rotation rotor (122). On the other hand, the regeneration-side fan (127) is provided downstream of the rotation rotor (122). As a result of operation of the regeneration-side fan (127), outdoor air is taken into the regeneration path (125). The outdoor air thus taken into the regeneration path (125) passes through the heater (126) and the rotation rotor (122) in this order, and after that, the air is introduced into the air duct (121).

The heating of the outdoor air taken into the regeneration path (125) may be carried out by utilizing the heat generated in the refrigerant circuit, instead of employing the heater (126).

The rotation rotor (122) is in a disc shape. Moreover, the rotation rotor (122) includes a substrate with a honeycomb structure and an adsorbent held on a surface of the substrate. Note that the “adsorbent” in this Description encompasses materials (so-called sorbents), which perform both adsorption and absorption of a target substance (for example, water vapor). The rotation rotor (122) is configured to allow passage of the air in the thickness direction thereof, so that the air passing through the rotation rotor (122) comes into contact with the adsorbent. The substrate of the rotation rotor (122) may be made from a material such as ceramic paper, glass fibers, organic compounds whose main component is cellulose (for example, paper), metals, and resins. These materials are small in specific heat, and therefore, the “adsorption/desorption portion” is small in heat capacity if the rotation rotor (122) serving as the “adsorption/desorption portion” is formed with such a material.

The rotation rotor (122) is, as described above, provided in such a posture that the rotation rotor (122) is positioned across both the dehumidification path (123) and the regeneration path (125). Specifically, the rotation rotor (122) is provided in such a posture that a desorption region (122b) of the rotation rotor (122) is positioned across the regeneration path (125). The desorption region (122b) is a circular-sector portion of the rotation rotor (122). Therefore, the air passing through the regeneration path (125) passes through the desorption region (122b) of the rotation rotor (122). Moreover, the rotation rotor (122) is provided in such a posture that an adsorption region (122a) of the rotation rotor (122) is positioned across the dehumidification path (123). The adsorption region (122a) is a remaining portion of the rotation rotor (122). Therefore, the air passing through the dehumidification path (123) passes through the adsorption region (122a) of the rotation rotor (122).

Note that the rotation rotor (122) is configured to rotate, be driven by a motor (not illustrated), about a center axis so as to move between the dehumidification path (123) and the regeneration path (125). Therefore, the portion that has been in contact with the air passing through the dehumidification path (123) by serving as the adsorption region (122a) of the rotation rotor (122) is moved to the regeneration path (125), that is, the desorption region (122b) by the rotation of the rotation rotor (122). On the other hand, the portion that has been in contact with the air passing through the regeneration path (125) by serving as the desorption region (122h) of the rotation rotor (122) is again moved to the dehumidification path (123), that is, the adsorption region (122a) by the rotation of the rotation rotor (122).

The adsorbent used for the rotation rotor (122) is a material that accumulates energy in adsorbing moisture and releases at least part of the energy in desorbing the moisture, for example, a material that converts adsorption and desorption thermal energies derived from the adsorption or desorption of the moisture into structural transition energy. As such a material, metal organic frameworks (flexible Metal-Organic Framework (flexible MOF)) being structurally flexible can be employed. Properties and the like of the adsorbent according to the present embodiment will be described later.

### Humidification

The air quality adjustment system as illustrated in FIG. 1 performs both the heating of the indoor air in the indoor unit (1) and supply of the air from the humidifying unit (120) under a heating operation. In this case, the refrigerant circuit in the air quality adjustment system as illustrated in FIG. 1 performs the heat pump operation with the refrigerant circulating. That is, the indoor heat exchanger (3) receives a high-temperature and high-pressure gaseous refrigerant discharged from the compressor. Moreover, as a result of operation of the indoor fan (4), the indoor air is taken into the indoor unit (1). The indoor air thus taken therein performs heat exchange with the gaseous refrigerant when passing through the indoor heat exchanger (3). The heat exchange causes the heating of the indoor air and condensation of the gaseous refrigerant.

In the humidifying unit (120), the dehumidification-side fan (124) and the regeneration-side fan (127) are operated and the heater (126) and the cooling portion (128) are turned on. Meanwhile, the rotation rotor (122) is rotated at a predetermined number of revolutions by a motor (not illustrated).

Into the dehumidification path (123), the outdoor air is taken. The outdoor air thus taken into the dehumidification path (123) is cooled down by the cooling portion (128), and sent to the adsorption region (122a) of the rotation rotor (122), so that the air comes into contact with the adsorbent. As a result of the contact with the outdoor air thus cooled, the adsorbent of the adsorption region (122a) is cooled, so that the moisture contained in the outdoor air is adsorbed in the adsorbent. The outdoor air thus dehumidified through the adsorption region (122a) of the rotation rotor (122) is exhausted outdoors.

As described above, the rotation rotor (1.22) is rotated at the predetermined number of revolutions. Therefore, the adsorbent that adsorbs therein the moisture from the outdoor air in the adsorption region (122a), that is, the dehumidification path (123) is moved to the desorption region (122b), that is, the regeneration path (125) by the rotation of the rotation rotor (122).

Into the regeneration path (125), the outdoor air is taken. The outdoor air thus taken into the regeneration path (125) is heated by the heater (126). The outdoor air thus heated is sent from the heater (126) to the desorption region (122b) of the rotation rotor (122), so that the outdoor air comes into contact with the adsorbent. As a result of the contact with the outdoor air thus heated, the adsorbent of the desorption region (122b) is heated, so that the moisture is desorbed from the adsorbent. The moisture thus desorbed from the adsorbent is sent to the air duct (121), together with the outdoor air having passed through the rotation rotor (122). That is, highly-humid air containing a large amount of moisture is introduced into the air duct (121). The highly-humid air is introduced into the indoor unit (1) via the air duct (121), and the indoor unit (1) exhausts the air indoors after the air is passed through the indoor heat exchanger (3).

On the other hand, the adsorbent thus regenerated by the moisture desorption in the desorption region (122b) is moved to the adsorption region (122a) by the rotation of the rotation rotor (122). As described above, the adsorbent is moved by the rotation of the rotation rotor (122) so as to repeat the moisture adsorption in the adsorption region (122a) and the moisture desorption in the desorption region (122b).

### Adsorbent

In the following, properties and the like exhibited in a case where the flexible MOF is employed as the adsorbent according to the present embodiment will he described.

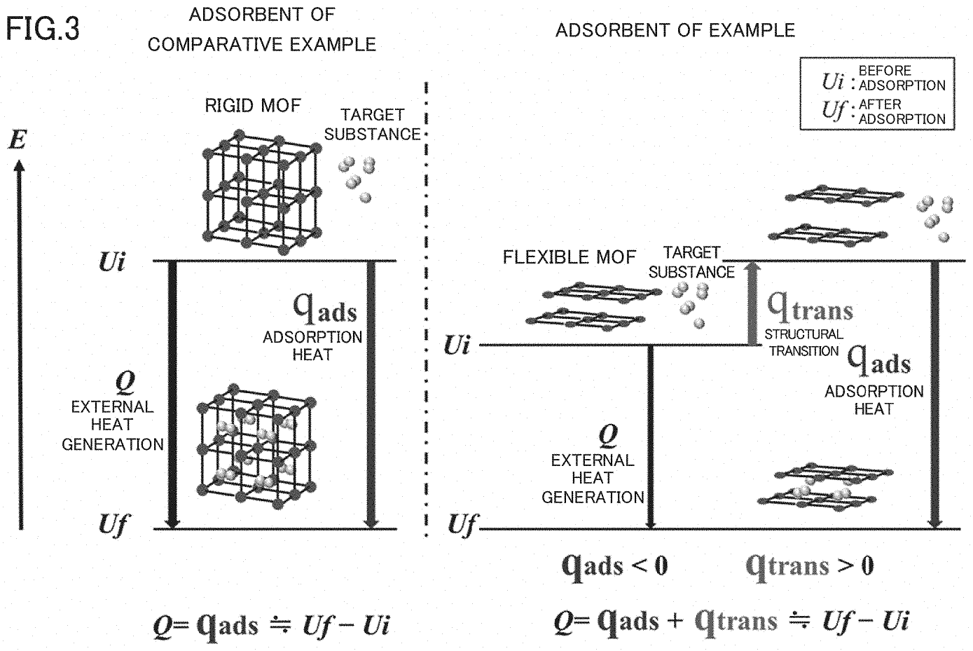

FIG. 3 is a view illustrating the properties of the adsorbent according to the present embodiment, more specifically, a heat balance thereof through the adsorption, in comparison with a rigid MOF.

As illustrated in FIG. 3, the flexible MOF exhibits a structural transition along the adsorption of a target substance (gaseous molecules), and heat absorption (qₜᵣₐₙₛ) due to the structural transition reduces external heat generation (Q) that would occur during the adsorption. Therefore, the external heat generation (Q) becomes smaller, compared with the rigid MOF in which adsorption heat (q_{ads}) directly becomes external heat generation (Q). As a result, the use of the flexible MOF makes adsorption operation of the target substance operable in a higher temperature range than existing adsorbent. Therefore, electric power necessary for cooling the flexible MOF during the adsorption operation can be lower.

Moreover, because the heat balance in the desorption is the reverse of the heat balance illustrated in FIG. 3, the use of the flexible MOF makes the desorption operation of the target substance operable in a lower temperature range than the existing adsorbent. Therefore, the electric power necessary for heating the flexible MOF during the desorption operation can be lower.

In the following, the external heat generation (endothermic heat absorption in the case of the desorption) may be merely referred to as adsorption heat (desorption heat in the case of the desorption).

The flexible MOF serving as an adsorbent can be prepared according to a process as below, for example. For rigid MOFs, various adsorbing materials for materials such as water and carbon dioxide have been developed already. A flexible MOF suitable for adsorption for the target substance (for example, water) may be prepared by redesigning such a rigid MOF in terms of a combination of a metal ion and an organic ligand (for example, a ligand with a hydrophilic group), an MOF structure and a pore size for a target molecular size, or the like.

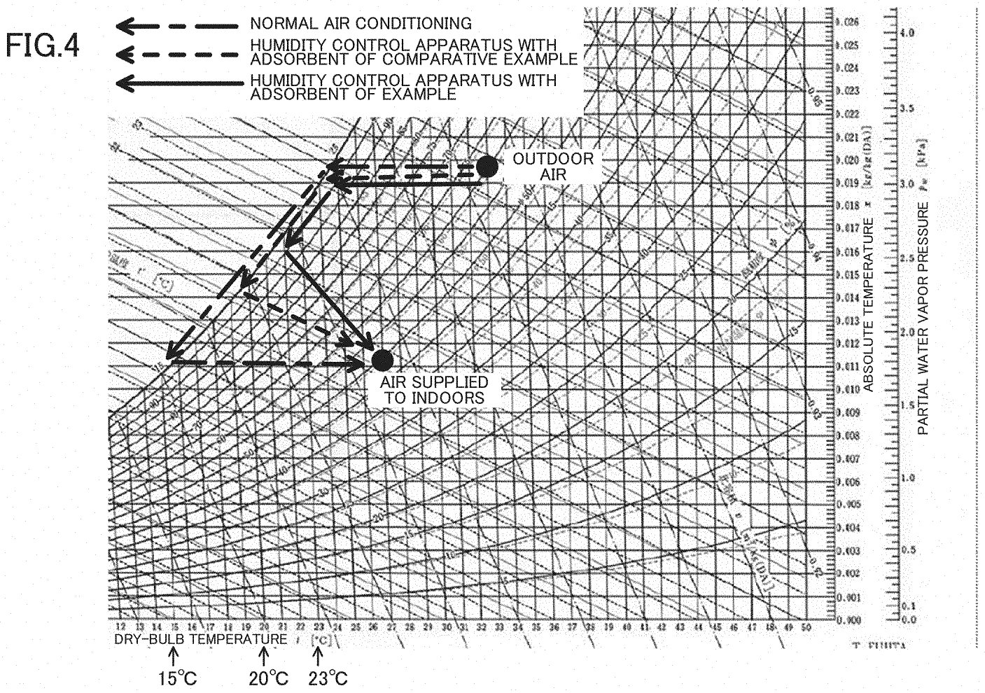

FIG. 4 illustrates one example of movements on a psychrometric chart for a case where dehumidification is carried out with the flexible MOF according to the present embodiment. FIG. 4 illustrates movements in a case where outdoor air (temperature: 33° C., absolute humidity: 18.5 g/kg) is subjected to the dehumidification and supplied indoors thereafter (temperature: 27° C., absolute humidity: 11 g/kg).

As illustrated in FIG. 4, in a case of an ordinary air conditioner without an adsorbent, it is necessary to cool the air to 15° C. in order to lower the absolute humidity to 11 g/kg. Moreover, a humidity control apparatus with a known adsorbent (Comparative Example) is such that, after the air is cooled to 20° C., the dehumidification is carried out by moisture adsorption with the adsorbent, which concurrently causes a temperature increase with the adsorption heat. At the time, the dehumidification takes place at temperatures on an isenthalpic curve, and therefore the temperature and the humidity move on the isenthalpic curve.

On the other hand, in the case where the flexible MOF is used (Example), it is possible to carry out the dehumidification until the absolute humidity of 11 g/kg is attained after the air is cooled to 23° C. without needing to cool the air to 20° C. Moreover, as described above, part of the adsorption heat generated during the moisture adsorption performed with the flexible MOF is offset with the heat absorption occurred along the structural transition of the to flexible MOF, and therefore the temperature increase at the dehumidification becomes smaller compared with the comparative example. The enthalpy of the air is reduced by the offset, and as a result of this, the dehumidification takes place at a temperature higher than the isenthalpic curve, as illustrated in FIG. 4.

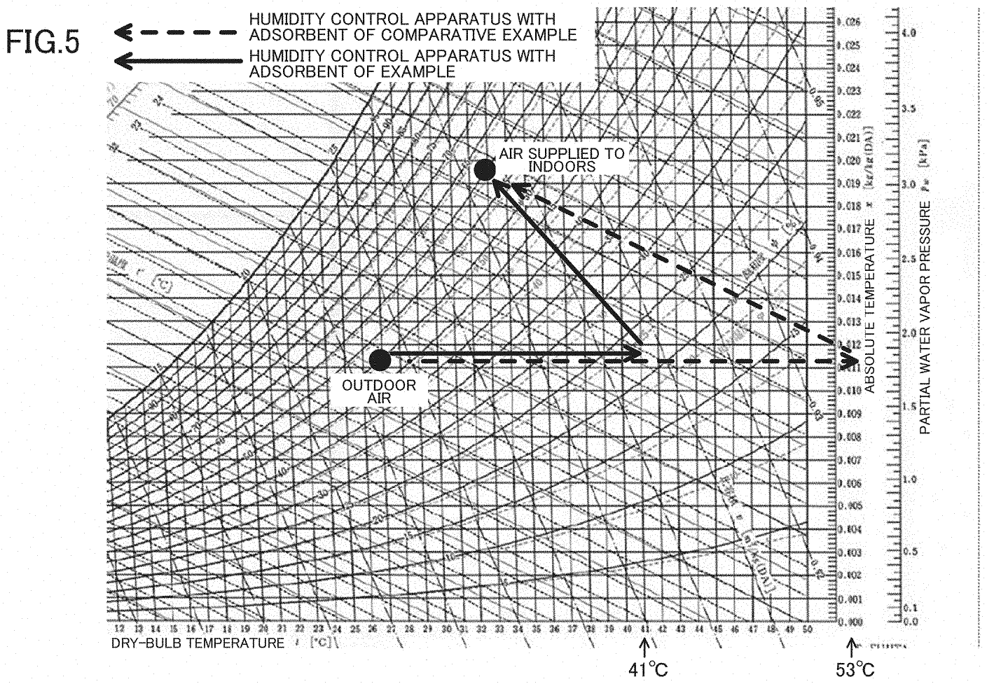

FIG. 5 illustrates one example of movements on a psychrometric chart for a case where humidification is carried out with the flexible MOF according to the present embodiment. FIG. 5 illustrates movements in a case where outdoor air (temperature: 27° C., absolute humidity: 11 g/kg) is subjected to the humidification and supplied indoors thereafter (temperature: 33° C., absolute humidity: 18.5 g/kg).

As illustrated in FIG. 5, a humidity control apparatus with a known adsorbent (Comparative Example) is such that, after the air is heated to 53° C., the humidification is carried out by moisture desorption from the adsorbent, which concurrently causes a temperature decrease with the desorption heat. At the time, the humidification takes place at temperatures on an isenthalpic curve, and therefore the temperature and the humidity move on the isenthalpic curve.

On the other hand, in the case where the flexible MOF is used (Example), it is possible to early out the humidification until the absolute humidity of 18.5 g/kg is attained after the air is heated to 41° C. without needing to heat the air to 53° C. Moreover, as described above, part of the desorption heat generated during the moisture desorption performed with the flexible MOF is offset with the heat generation occurred along the structural transition of the flexible MOF, and therefore the temperature decrease at the humidification becomes smaller, compared with the comparative example. The enthalpy of the air is increased by the offset, and as a result of this, the humidification takes place at a temperature lower than the isenthalpic curve, as illustrated in FIG. 5.

The psychrometric charts illustrated in FIGS. 4 and 5 illustrate the air states obtained by excluding, from air states of air flowing out from the adsorption/desorption portion (the adsorption region or the desorption region) with the adsorbent, “residual energy in the target substance (water in these Examples) adsorbed and desorbed by the adsorption/desorption portion,” “air friction heat in the adsorption/desorption portion,” and “heat balance due to the heat capacity of the adsorption/desorption portion.” The “residual energy in the target substance) adsorbed and desorbed by the adsorption/desorption portion, “air friction heat in the adsorption/desorption portion,” and “heat balance due to the heat capacity of the adsorption/desorption portion are all measurable or calculable values.”

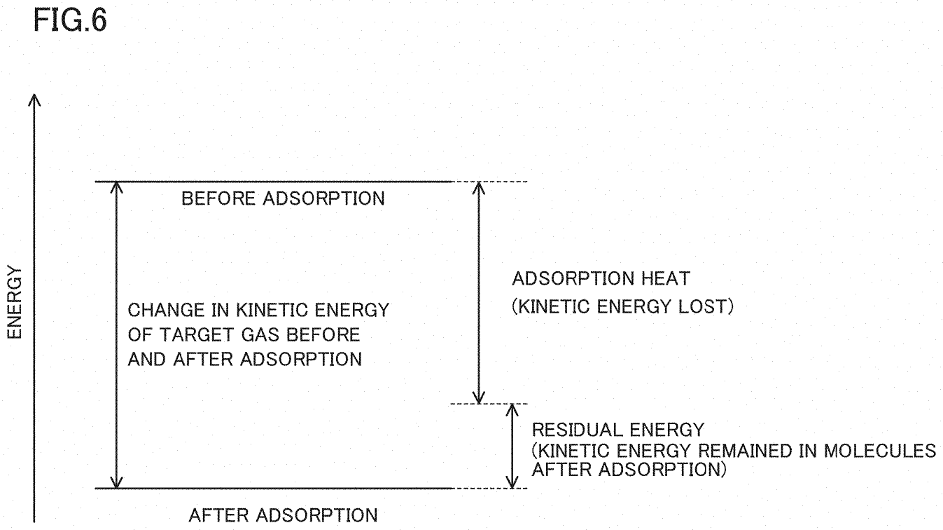

FIG. 6 is a view illustrating the residual energy in the target substance adsorbed and desorbed by the adsorption/desorption portion, explaining the residual energy of the target substance in the case where the target substance (gas) is adsorbed with the adsorbent. That is, the residual energy in the target substance is an energy that the target gas molecules have even after being adsorbed to the adsorbent. An energy relationship in the desorption is the reverse of the energy relationship illustrated in FIG. 6.

Moreover, what is meant by the air friction heat in the adsorption/desorption portion is heat caused by friction at a boundary layer or the like of the adsorption/desorption portion when air with a velocity contacts with the adsorption/desorption portion.

Moreover, the heat balance due to the heat capacity of the adsorption/desorption portion is determined in dependence of a specific heat of the material constituting the adsorption/desorption portion, and if the specific heat is smaller, the heat capacity of the adsorption/desorption portion is smaller.

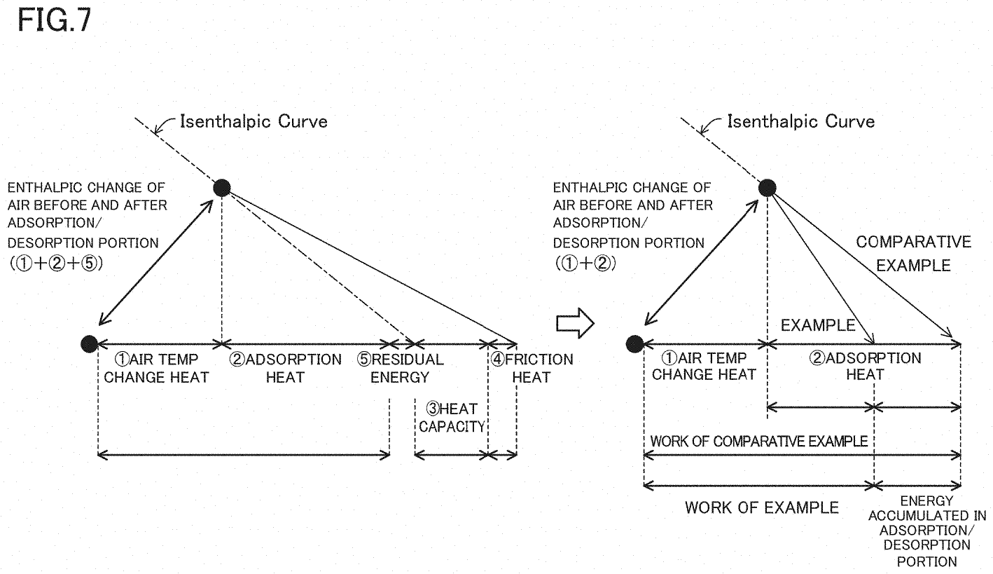

FIG. 7 is a schematic view illustrating an air state in the case of adsorbing the target substance to the flexible MOF. As illustrated in the left part of FIG. 7, when the “residual energy in the target substance adsorbed and desorbed by the adsorption/desorption portion (hereinafter, this will he simply referred to as the “residual energy”),” the “air friction heat in the adsorption/desorption portion (this will be simply referred to as the “friction heat”),” and the “heat balance due to the heat capacity of the adsorption/desorption portion” (hereinafter, this will be simply referred to as “heat capacity”) are taken into consideration, an enthalpy change (energy difference) of the air between before and after passing the adsorption/desorption portion (adsorption region) is “air temperature change heat”+“adsorption heat”+“residual energy”. Moreover, work for the cooling necessary for the adsorption operation is “air temperature change heat”+“adsorption heat”+“heat capacity”+“friction heat.”

Moreover, considering the air states from which the “heat capacity,” “friction heat,” and “residual energy,” are excluded, the enthalpy change of the air between before and after passing the adsorption region is “air temperature change heat” “adsorption heat” and the work for the cooling necessary for the adsorption operation in the case of employing the known adsorbent (Comparative Example) is also “air temperature change heat”+“adsorption heat,” as illustrated in the right portion of FIG. 7. Therefore, in the Comparative Example, the adsorption operation takes place on the isenthalpic curve as illustrated in the right portion of FIG. 7. On the other hand, in the case of employing the flexible MOF (Example), the “energy accumulated in the adsorption/desorption portion” causes reduction of the “adsorption heat (external heat generation),” so that the work for the cooling necessary for the adsorption operation becomes smaller than the energy difference of the air between before and after passing the adsorption region, as illustrated in the right portion of FIG. 7.

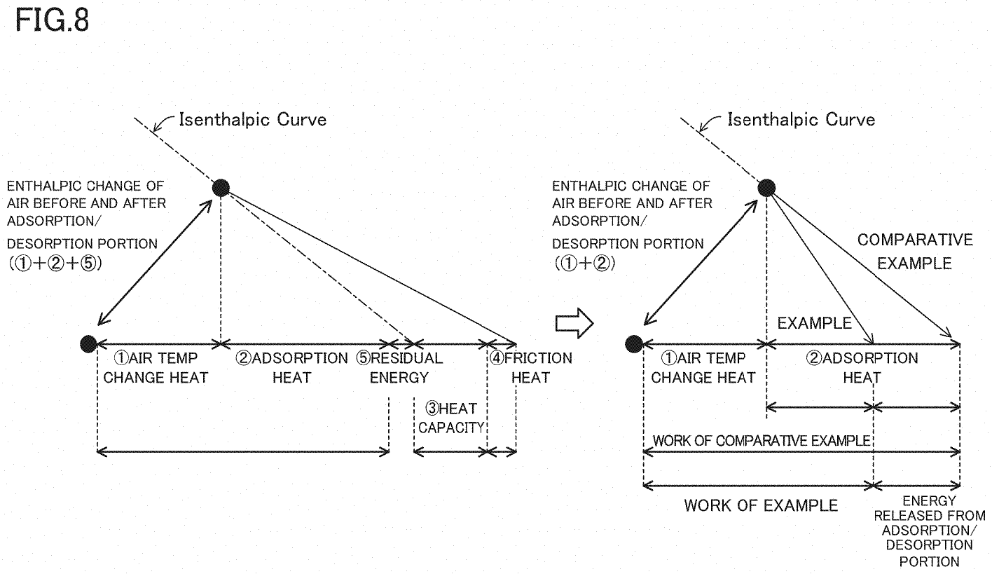

FIG. 8 is a schematic view illustrating an air state in the case of desorbing the target substance from the flexible MOF. As illustrated in the left part of FIG. 8, considering the “residual energy.” “friction heat,” and “heat capacity,” the enthalpy change (energy difference) of the air between before and after passing the adsorption/desorption portion (desorption region) is “air temperature change heat”+“desorption heat”+“residual energy.” Moreover, work for the heating necessary for the desorption is “air temperature change heat”+“desorption heat”+“heat capacity”−“friction heat.”

On the other hand, as illustrated in the right portion of FIG. 8, considering the air state from which the “heat capacity,” “friction heat,” and “residual energy,” are excluded, the enthalpy change of the air between before and after passing the desorption region is “air temperature change heat”+“desorption heat,” and the work for heating necessary for the desorption in the case of employing the known adsorbent (Comparative Example)” is “air temperature change heat”+“desorption heat.” Therefore, in Comparative Example, the desorption takes place on the isenthalpic curve as illustrated in the right portion of FIG. 8. On the other hand, in the case of employing the flexible MOF (Example), the “energy released from the adsorption/desorption portion” causes reduction of the “desorption heat (endothermic heat absorption),” so that the work for the heating necessary for the desorption becomes smaller than the energy difference of the air between before and after passing the desorption region, as illustrated in the right portion of FIG. 8.

As described above, the cooling portion and heating portion (which are collectively referred to as “adjustment portion”) for adjusting the temperature of the adsorption/desorption portion in which the flexible MOF is employed is configured such that in performing the adsorption the adjustment portion deprives from the adsorption/desorption portion an energy amount smaller than the energy difference of the air between before and after passing the adsorption/desorption portion and in performing the desorption the adjustment portion gives such an energy amount to the adsorption/desorption portion, in terms of the energy balance from which the “heat capacity,” “friction heat,” and “residual energy” are excluded.

### Advantages of First Embodiment

According to the first embodiment described so far, part of the adsorption thermal energy is accumulated in the adsorption/desorption. portion (122) when adsorbing the target substance, and this makes it possible for the adsorption/desorption portion (122) to be operable in a higher temperature range in the adsorption than the existing arts, Moreover, the energy accumulated in the adsorption/desorption portion (122) is released when desorbing the target substance, and this makes it possible for the adsorption/desorption portion (122) to be operable in a lower temperature range than the existing arts. Therefore, it becomes possible for an air quality adjustment system to attain power consumption reduction.

Moreover, according to the first embodiment described so far, the adsorption of the target substance is carried out in such a way that the adsorption/desorption portion (122) adsorbs the target substance at a temperature higher than the isenthalpic curve of the air state of the air flowing out from the adsorption region (122a) (excluding the “heat capacity,” “friction heat,” and “residual energy”). This makes it possible for the adsorption/desorption portion (122) to be operable in a higher temperature range in the adsorption than the existing arts. Therefore, it becomes possible for an air quality adjustment system to attain power consumption reduction.

Moreover, according to the first embodiment described so far, the desorption of the target substance is carried out in such a way that the adsorption/desorption portion (122) desorbs the target substance at a temperature lower than the isenthalpic curve of the air state of the air flowing out from the desorption region (122b) (excluding the “heat capacity,” “friction heat.” and “residual energy”). This makes it possible for the adsorption/desorption portion (122) to be operable in a lower temperature range in the desorption than the existing arts. Therefore, it becomes possible for an air quality adjustment system to attain power consumption reduction.

Moreover, according to the first embodiment, the adsorption of the target substance is carried out in such a way that the cooling portion (128) deprives from the adsorption/desorption portion (122) an energy amount smaller than the energy difference of the air between before and after passing through the adsorption/desorption portion (122), and therefore this makes it possible for the adsorption/desorption portion (122) to be operable in a higher temperature range in the adsorption than in the existing arts. Moreover, according to the first embodiment, the desorption of the target substance is carried out in such a way that the heating portion (126) supplies the adsorption/desorption portion (122) with an energy amount smaller than the energy difference of the air between before and after passing the adsorption/desorption portion (122), thereby making it possible for the adsorption/desorption portion (122) to be driven in a lower temperature range in the adsorption than existing arts. Therefore, it becomes possible for an air quality adjustment system to attain power consumption reduction.

Moreover, according to the first embodiment, the adsorption/desorption portion (122) is made from a material, which converts, into a structural transition energy, adsorption and desorption thermal energies generated due to the adsorption or desorption of the target substance. This allows the adsorption/desorption portion (122) to accumulate an energy in adsorbing the target substance and release, in desorbing the target substance, at least part of the energy accumulated. Especially, in the case where the flexible MOF is employed, the adsorption/desorption portion (122) is made from a material, which converts, into a structural transition energy, adsorption and desorption thermal energies generated due to the adsorption or desorption of the target substance.

Moreover, according to the first embodiment, it becomes possible to perform the humidification of the indoor air by using the moisture contained in the outdoor air. Thus, this makes it unnecessary to externally supply tap water or the like for the humidification, thereby making it possible to realize so-called waterless humidification.

### Variations of First Embodiment

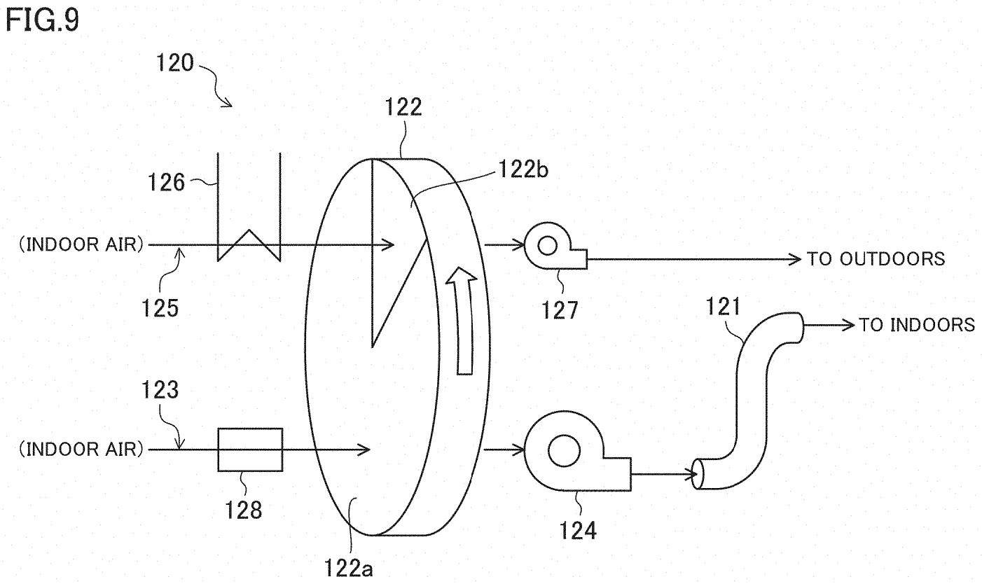

As illustrated in FIG. 9, a dehumidifying unit (130) may be provided instead of the humidifying unit (120) according to the first embodiment. Note that the same components as in the humidifying unit (120) illustrated in FIG. 2 are labeled with the same reference characters in FIG. 9.

A first difference between a configuration of the dehumidifying unit (130) and that of the humidifying unit (120) is in that operation of the dehumidification-side fan (124) causes the indoor air to be taken into the dehumidification path (123), so that the indoor air is subjected to dehumidification by passing through the rotation rotor (122), and thereafter is returned indoors via the air duct (121). A second difference between a configuration of the dehumidifying unit (130) and that of the humidifying unit (120) is in that operation of the regeneration-side fan (127) causes the indoor air to be taken into the regeneration path (125), so that the indoor air is subjected to humidification by passing through the rotation rotor (122), and thereafter is exhausted outdoors.

### Advantages of Variation of First Embodiment

This variation described above can also provide advantages similar to those of the first embodiment by employing, as the adsorbent held on the rotation rotor (122), an adsorbent similar to that in the first embodiment.

Moreover, by applying the configuration of the dehumidifying unit (130) of this variation, it is possible to realize a so-called room dryer, a carbon dioxide absorbing device, or the like device without a need of ventilation.

### Second Embodiment

A second embodiment will be described below with reference to the drawings.

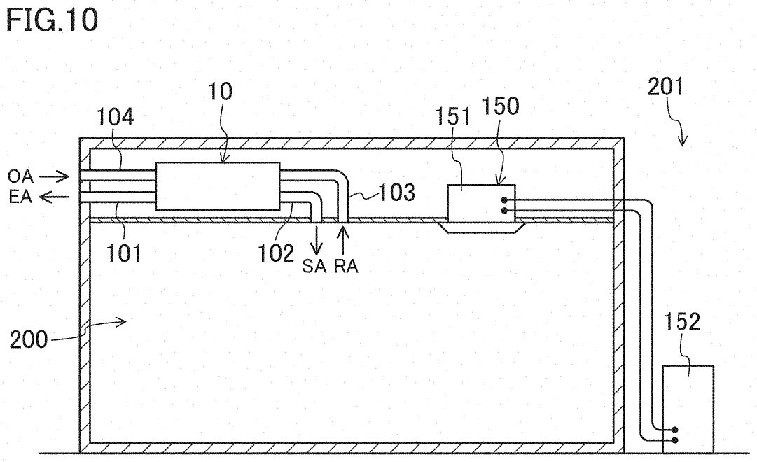

A humidity control apparatus (10) as illustrated in FIG. 10, which is an air quality adjustment system according to the present embodiment, is for humidity control in an indoor space (200) and ventilation of the indoor space (200), and is configured such that humidity control apparatus (10) takes outdoor air (OA) therein and performs humidity adjustment for the outdoor air, and supplies the outdoor air into the indoor space (200), and exhausts the taken indoor air (RA) to an outdoor space (201).

The humidity control apparatus (10) is installed inside a building together with an air conditioner (150). The air conditioner (150) includes an outdoor unit (152) and an indoor unit (151) and selectively performs cooling operation and heating operation. Via the ducts (102, 103), the humidity control apparatus (10) is connected with the indoor space (200) into which the indoor unit (151) of the air conditioner (150) blows out air. More specifically, the humidity control apparatus (10) is connected with the indoor space (200) via an air supply duct (102) and an indoor air suction duct (103), and connected with the outdoor space (201) via an exhaust duct (101) and an outdoor air suction duct (104).

### General Configuration of Humidity Control Apparatus

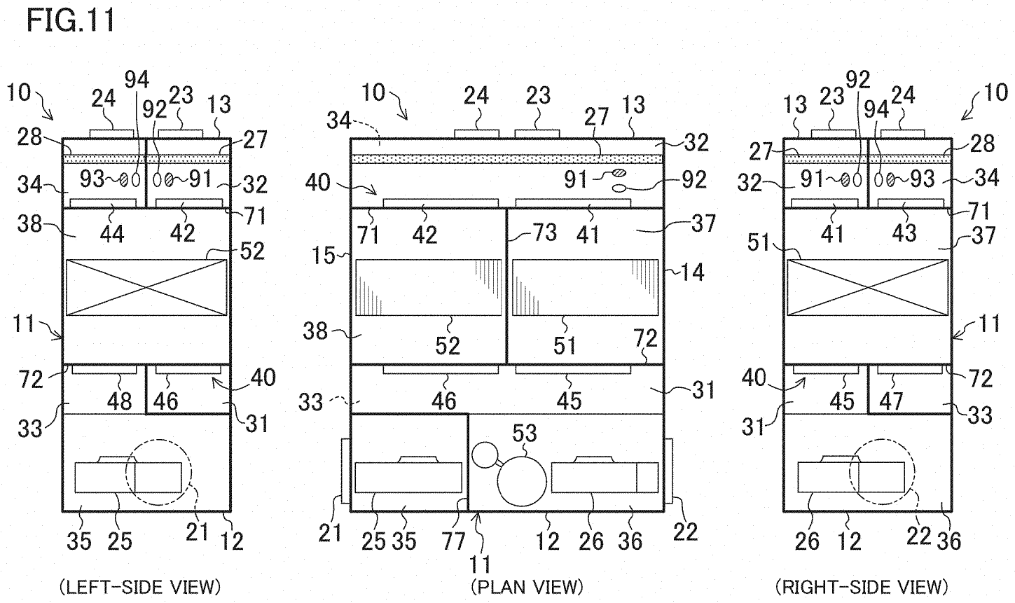

The humidity control apparatus (10) will be described in detail below with reference to FIG. 11. Unless otherwise specified, the terms in the following description which indicate directions, such as “upper,” “top,” “lower,” “bottom,” “right,” “left,” “front,” and “rear,” refer to the directions when the humidity control apparatus (10) is viewed from the front.

The humidity control apparatus (10) includes a casing (11). The casing (11) houses therein a refrigerant circuit (50). The refrigerant circuit (50) is connected with a first adsorption heat exchanger (51), a second adsorption heat exchanger (52), a compressor (53), a four-way switching valve (54), and an electrically powered expansion valve (55). The first refrigerant circuit (50) will be described in detail later.

The casing (11) has a rectangular parallelepiped and slightly flattened shape with a height relatively shorter than its width and length. The casing (11) includes an outdoor air inlet (24), an indoor air inlet (23), an air supply port (22), and an exhaust port (21). The outdoor air inlet (24) is connected with the outdoor air suction duct (104), the indoor air inlet (23) is connected with the indoor air suction duct (103), the air supply port (22) is connected with the air supply duct (102), and the exhaust port (21) is connected with the exhaust duct (101).

The outdoor air inlet (24) and the indoor air inlet (23) are provided on a back panel portion (13) of the casing (11). The outdoor air inlet (24) is provided on a lower portion of the back panel portion (13). The indoor air inlet (23) is provided on an upper portion of the back panel portion (13). The air supply port (22) is provided on a first side panel portion (14) of the casing (11). On the first side panel portion (14), the air supply port (22) is provided in the vicinity of an edge associated with a front panel portion (12) of the casing (11). The exhaust port (21) is provided on a second side panel portion (15) of the casing (11). On the second side panel portion (15), the exhaust port (21) is provided in the vicinity of an edge associated with the front panel portion (12).

An upstream partition plate (71), a downstream partition plate (72), and a center partition plate (73) are provided inside the casing (11). All of these partition plates (71 to 73) are provided to stand on a bottom plate of the casing (11) so as to partition an internal space of the casing (11), extending from the bottom plate to a top panel of the casing (11).

The upstream partition plate (71) and the downstream partition plate (72) are provided with a predetermined interval in a front-to-back direction of the casing (11) parallel with the front panel portion (12) and the back panel portion (13). The upstream partition plate (71) is closer to the back panel portion (13) than to the front panel portion (12). The downstream partition plate (72) is closer to the front panel portion (12) than to the back panel portion (13). Details of the center partition plate (73) will be described later.

Inside the casing (11), a space between the upstream partition plate (71) and the back panel portion (13) is partitioned into two spaces, one of which is above the other, and the upper one of the spaces constitutes an indoor air path (32) and the lower one of the spaces constitutes an outdoor air path (34). The indoor air path (32) is in fluid communication with the indoor space (200) via the duct connected with the indoor air inlet (23). The outdoor air path (34) is in fluid communication with the outdoor space (201) via the duct connected with the outdoor air inlet (24).

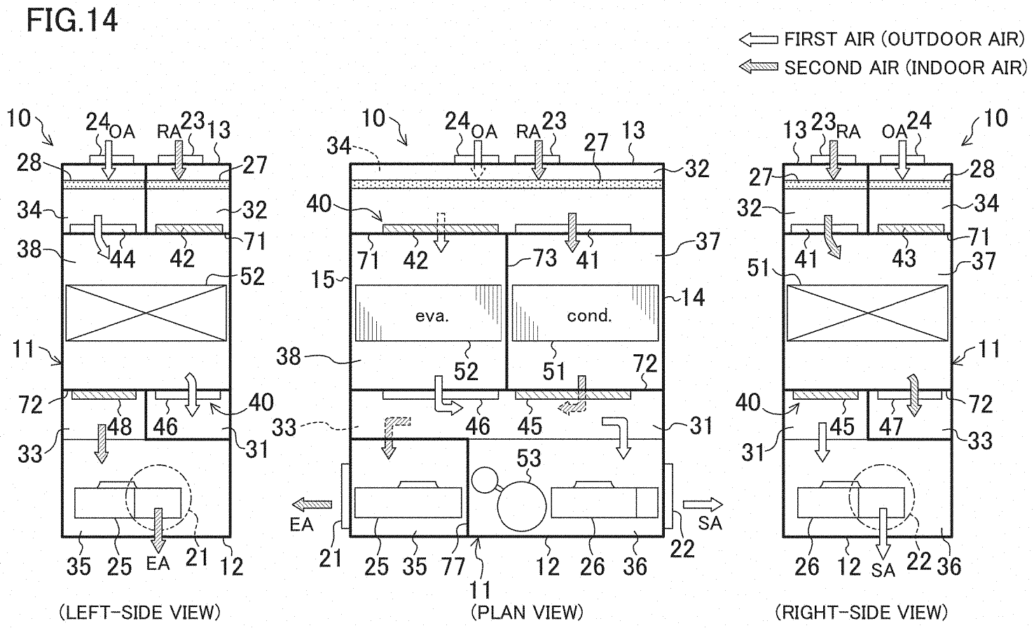

The indoor air path (32) is provided with an indoor air-side filter (27), an indoor air temperature sensor (91), and an indoor air humidity sensor (92). The indoor air temperature sensor (91) is configured to measure a temperature of the indoor air flowing through the indoor air path (32), The indoor air humidity sensor (92) is configured to measure a relative humidity of the indoor air flowing through the indoor air path (32). On the other hand, the outdoor air path (34) is provided with an outdoor air-side filter (28), an outdoor air temperature sensor (93), and an outdoor air humidity sensor (94). The outdoor air temperature sensor (93) is configured to measure a temperature of the outdoor air flowing through the outdoor air path (34). The outdoor air humidity sensor (94) is configured to measure a relative humidity of the outdoor air flowing through the outdoor air path (34). Note that the indoor air temperature sensor (91), the indoor air humidity sensor (92), the outdoor air temperature sensor (93), and the outdoor air humidity sensor (94) are not illustrated in FIGS. 14 to 17 referred later.

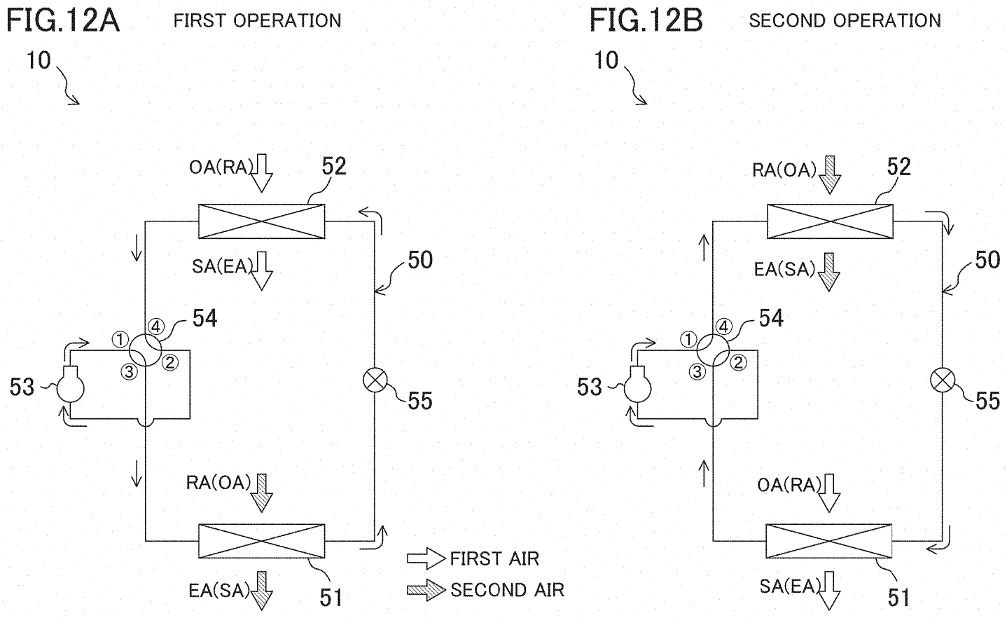

Inside the casing (11), a space between the upstream partition plate (71) and the downstream partition plate (72) is partitioned into two spaces with the center partition plate (73), one of which is on the left or right-hand side of the other, and the right one of the spaces constitutes a first heat exchanger compartment (37) and the left one of the spaces constitutes a second heat exchanger compartment (38). The first heat exchanger compartment (37) houses therein the first adsorption heat exchanger (51) serving as a “first adsorption/desorption portion.” The second heat exchanger compartment (38) houses therein the second adsorption heat exchanger (52) serving as a “second adsorption/desorption portion.” Moreover, even though not illustrated herein, the first heat exchanger compartment (37) houses therein the electrically powered expansion valve (55) of the refrigerant circuit (50) (see FIGS. 12A and 12B).

The adsorption heat exchangers (51, 52) are so-called cross-fin-type fin-and-tube heat exchangers with an adsorbent held on a surface thereof The adsorbent is similar to the one employed in the first embodiment.

The adsorption heat exchangers (51, 52) have a rectangular thick plate-like shape or a rectangular parallelepiped flattened shape, as a whole. The adsorption heat exchangers (51, 52) are provided to stand inside the respective heat exchanger compartments (37, 38) in such a way that a front side and a back side of each of the adsorption heat exchangers (51, 52) are parallel with the upstream partition plate (71) and the downstream partition plate (72).

Inside the casing (11), a space along a front surface of the downstream partition plate (72) is partitioned into spaces, one of which is above the other, and the upper space constitutes the air supply-side path (31) and the lower space constitutes the exhaust-side path (33).

The upstream partition plate (71) is provided with four dampers (41) to (44), which are openable. The dampers (41) to (44) are substantially rectangular in shape with a width longer than a height. More specifically, the upstream partition plate (71) is such that a portion facing the indoor air path (32) (an upper portion) is provided with a first indoor air damper (41) on a right portion thereof with respect to the center partition plate (73) and a second indoor air damper (42) on a left portion thereof with respect to the center partition plate (73). Moreover, the upstream partition plate (71) is such that a portion facing the outdoor air path (34) (a lower portion) is provided with a first outdoor air damper (43) on a right portion thereof with respect to the center partition plate (73) and a second outdoor air damper (44) on a left portion thereof with respect to the center partition plate (73). The four dampers (41) to (44) provided to the upstream partition plate (71) constitute a switching mechanism (40) for switching over air flow paths.

The downstream partition plate (72) is provided with four dampers (45) to (48), which are openable. The dampers (45) to (48) are substantially rectangular in shape with a width longer than a height. More specifically, the downstream partition plate (72) is such that a portion facing air supply-side path (31) (an upper portion) is provided with a first air supply-side damper (45) on a right portion thereof with respect to the center partition plate (73) and a second air supply-side damper (46) on a left portion thereof with respect to the center partition plate (73). Moreover, the downstream partition plate (72) is such that a portion facing the exhaust-side path (33) (a lower portion) is provided with a first exhaust-side damper (47) on a right portion thereof with respect to the center partition plate (73) and a second exhaust-side damper (48) on a left portion thereof with respect to the center partition plate (73). The four dampers (45) to (48) provided to the downstream partition plate (72) constitute a switching mechanism (40) for switching over air flow paths.

Inside the casing (11), a space between the air supply-side path (31) and the exhaust-side path (33), and the front panel portion (12) is partitioned with a partition plate (77) in such a way that a space on the right-hand side of the partition plate (77) constitutes an air supply fan compartment (36) and a space on the left-hand side of the partition plate (77) constitutes an exhaust fan compartment (35).

The air supply fan compartment (36) houses an air supply fan (26) therein. The exhaust fan compartment (35) houses an exhaust fan (25) therein. The air supply fan (26) and the exhaust fan (25) are centrifugal multiblade fans (so-called sirocco fans). The air supply fan (26) is configured to blow out, to the air supply port (22), the air taken in from beyond the downstream partition plate (72). The exhaust fan (25) is configured to blow out, to the exhaust port (21), the air taken in from beyond the downstream partition plate (72).

The air supply fan compartment (36) houses the compressor (53) and the four-way switching valve (54) of the refrigerant circuit (50). The compressor (53) and the four-way switching valve (54) are disposed between the air supply fan (26) and the partition plate (77) in the air supply fan compartment (36).

### Configuration of Refrigerant Circuit

As illustrated in FIGS. 12A and 12B, the refrigerant circuit (50) is a closed circuit including the first adsorption heat exchanger (51), the second adsorption heat exchanger (52), the compressor (53), the four-way switching valve (54), and the electrically powered expansion valve (55). The refrigerant circuit (50) circulates therethrough a refrigerant filled therein, so as to perform a vapor compression refrigeration cycle. The refrigerant circuit (50) is provided with a plurality of temperature sensors and a plurality of pressure sensors, even though the sensors are not illustrated herein.

The refrigerant circuit (50) is configured such that the compressor (53) has a discharge pipe connected with a first port of the four-way switching valve (54) and a suction pipe connected with a second port of the four-way switching valve (54). Moreover, the refrigerant circuit (50) is configured such that the first adsorption heat exchanger (51), the electrically powered expansion valve (55), and the second adsorption heat exchanger (52) are arranged in this order from a third port to a fourth port of the four-way switching valve (54).

The four-way switching valve (54) is switchable between a first state (a state illustrated in FIG. 12A) in which the first and third ports are in fluid communication with each other and the second and fourth ports are in fluid communication with each other, and a second state (a state illustrated in FIG. 12B) in which the first and fourth ports are in fluid communication with each other and the second and third ports are in fluid communication with each other.

The compressor (53) is a closed-type compressor, in which a compression mechanism and an electric motor for driving the compression mechanism are housed in a casing. The electric motor for the compressor (53) is supplied with an alternating current via an inverter. When an output frequency of the inverter (i.e., an operation frequency of the compressor (53)) is changed, rotational speeds of the electric motor and the compression mechanism driven by the electric motor change, and as a result, an operating capacity of the compressor (53) changes. An increase in the rotational speed of the compression mechanism increases the operating capacity of the compressor (53) and a decrease in the rotational speed of the compression mechanism decreases the operating capacity of the compressor (53).

### Configuration of Controller

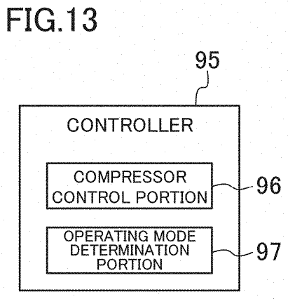

The humidity control apparatus (10) is provided with a controller (95) as illustrated in FIG. 13. Measurement values of the indoor air humidity sensor (92), the indoor air temperature sensor (91), the outdoor air humidity sensor (94), and the outdoor air temperature sensor (93) are inputted to the controller (95). Moreover, measurement values of the temperature sensors and the pressure sensors provided to the refrigerant circuit (50) are inputted to the controller (95). moreover, signals indicative of an operating state of the air conditioner (150) (for example, a signal indicating whether or not the air conditioner (150) is in operation, a signal indicating whether the operation of the air conditioner (150) is a cooling operation or a heating operation) are inputted to the controller (95). The controller (95) performs operation control of the humidity control apparatus (10) on the basis of these measurement values and signals inputted. In other words, the controller (95) is configured to control the operations of the dampers (41) to (48), the fans (25) and (28), the compressor (53), the electrically powered expansion valve (55), and the four-way switching valve (54).

As illustrated in FIG. 13, the controller (95) includes a compressor control portion (96) and an operating mode determination portion (97). The compressor control portion (96) sets a target value of the operation frequency of the compressor (53) on the basis of the measurement values of the sensors (91) to (94) and/or the like. The operating mode determination portion (97) is configured to select, on the basis of the measurement values measured by the sensors (91) to (94), the signals indicative of the operating state of the air conditioner (150), and the like, an operation to be carried out by the humidity control apparatus (10).

### Operation

The humidity control apparatus (10) of the present embodiment selectively performs the dehumidifying operation, the humidifying operation, the cooling operation, the heating operation, and simple ventilating operation. The dehumidifying operation and the humidifying operation are humidity adjusting operations for adjusting the absolute humidity of the outdoor air to be supplied to the indoor space (200). That is, the dehumidifying operation and the humidifying operation are operations for treating latent heat load (dehumidification load or humidification load) mainly of the indoor space (200). The cooling operation and the heating operation are sensible heat-treating operations for adjusting the temperature of the outdoor air to be supplied to the indoor space (200). That is, the cooling operation and the heating operation are operations for treating sensible heat load (cooling load or heating load) mainly of the indoor space (200). The simple ventilating operation is an operation simply for ventilating the indoor space (200).

For each of the dehumidifying operation, the humidifying operation, the cooling operation, the heating operation, and the simple ventilating operation, the air supply fan (26) and the exhaust fan (25) are operated. Furthermore, the humidity control apparatus (10) is configured to take the outdoor air (OA) therein and supply the outdoor air (OA) to the indoor space (200) as the supply air (SA), and to take the indoor air (RA) therein and exhaust the indoor air (RA) to the outdoor space (201) as the exhaust air (EA).

Hereinafter, the dehumidifying operation and the humidifying operation performed by the humidity control apparatus (10) will he described in detail.

### Dehumidifying Operation

In the dehumidifying operation, the humidity control apparatus (10) takes, as first air, the outdoor air via the outdoor air inlet (24) into the casing (11), and takes, as second air, the indoor air via the indoor air inlet (23) into the casing (11). Moreover, in the refrigerant circuit (50), the compressor (53) operates and an opening degree of the electrically powered expansion valve (55) is adjusted. Thereafter, the humidity control apparatus (10) under the dehumidifying operation repeats the first and second operations (described later) each for 3 min, alternatively. That is, the dehumidifying operation is such that a first predetermined period, which is a time period for which the first or second operation is continued, is 3 min.

As illustrated in FIG. 14, the first operation of the dehumidifying operation is such that the switching mechanism (40) switches over the air flow path to the second path. More specifically, the first indoor air damper (41), the second outdoor air damper (44), the second air supply-side damper (46), and the first exhaust-side damper (47) are open, and the second indoor air damper (42), the first outdoor air damper (43), the first air supply-side damper (45), and the second exhaust-side damper (48) are closed. Moreover, in the first operation, the four-way switching valve (54) is in the first state (the state illustrated in FIG. 12A). In this way, the refrigerant circuit (50) performs the refrigeration cycle, in which the first adsorption heat exchanger (51) functions as a condenser (that is, a heat radiator) and the second adsorption heat exchanger (52) functions an evaporator.

The first air flowing into the outdoor air path (34) flows into the second heat exchanger compartment (38) via the second outdoor air damper (44), and thereafter passes through the second adsorption heat exchanger (52). In the second adsorption heat exchanger (52), the moisture in the first air is adsorbed in the adsorbent, and the adsorption heat generated in the adsorption is absorbed by the refrigerant. Accordingly, the second adsorption heat exchanger (52) lowers the temperature of the first air to some extent. The first air thus dehumidified by the second adsorption heat exchanger (52) flows into the air supply-side path (31) via the second air supply-side damper (46), and, after passing the air supply fan compartment (36), is supplied to the indoor space (200) via the air supply port (22).

On the other hand, the second air flowing into the indoor air path (32) flows into the first heat exchanger compartment (37) via the first indoor air damper (41), and thereafter passes through the first adsorption heat exchanger (51). In the first adsorption heat exchanger (51), the moisture is desorbed from the adsorbent heated by the refrigerant, and the moisture thus desorbed is added to the second air, The second air thus humidified by the first adsorption heat exchanger (51) flows into the exhaust-side path (33) via the first exhaust-side damper (47), and, after passing the exhaust fan compartment (35), is supplied to the outdoor space (201) via the exhaust port (21).

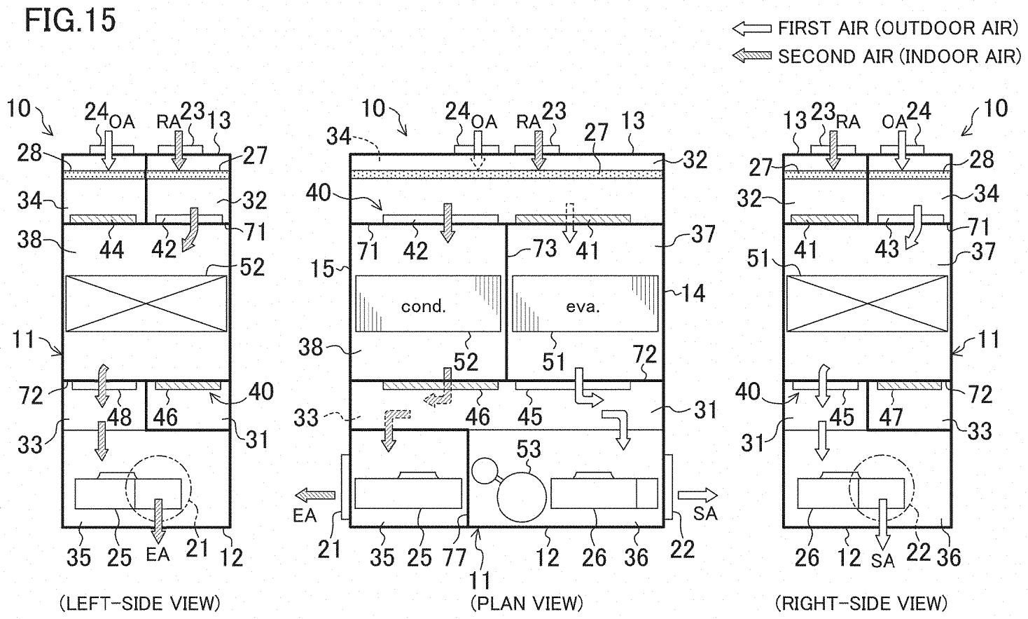

As illustrated in FIG. 15, the second operation of the dehumidifying operation is such that the switching mechanism (40) switches over the air flow path to the first path. More specifically, the second indoor air damper (42), the first outdoor air damper (43), the first air supply-side damper (45), and the second exhaust-side damper (48) are open, and the first indoor air damper (41), the second outdoor air damper (44), the second air supply-side damper (46), and the first exhaust-side damper (47) are closed. Moreover, in the second operation, the four-way switching valve (54) is in the second state (the state illustrated in FIG. 12B). In this way, the refrigerant circuit (50) performs the refrigeration cycle, in which the second adsorption heat exchanger (52) functions as a condenser (that is, a heat radiator) and the first adsorption heat exchanger (51) functions an evaporator.

The first air flowing into the outdoor air path (34) flows into the first heat exchanger compartment (37) via the first outdoor air damper (43), and thereafter passes through the first adsorption heat exchanger (51). In the first adsorption heat exchanger (51), the moisture in the first air is adsorbed in the adsorbent, and the adsorption heat generated in the adsorption is absorbed by the refrigerant. Accordingly, the first adsorption heat exchanger (51) lowers the temperature of the first air to some extent. The first air thus dehumidified by the first adsorption heat exchanger (51) flows into the air supply-side path (31) via the first air supply-side damper (45), and, after passing the air supply fan compartment (36), is supplied to the indoor space (200) via the air supply port (22).

On the other hand, the second air flowing into the indoor air path (32) flows into the second heat exchanger compartment (38) via the second indoor air damper (42), and thereafter passes through the second adsorption heat exchanger (52). In the second adsorption heat exchanger (52), the moisture is desorbed from the adsorbent heated by the refrigerant, and the moisture thus desorbed is added to the second air. The second air thus humidified by the second adsorption heat exchanger (52) flows into the exhaust-side path (33) via the second exhaust-side damper (48), and, after passing the exhaust fan compartment (35), is supplied to the outdoor space (201) via the exhaust port (21).

### Humidifying Operation

In the humidifying operation, the humidity control apparatus (10) takes, as second air, the outdoor air via the outdoor air inlet (24) into the casing (11), and takes, as first air, the indoor air via the indoor air inlet (23) into the casing (11). Moreover, in the refrigerant circuit (50), the compressor (53) operates and an opening degree of the electrically powered expansion valve (55) is adjusted. Thereafter, the humidity control apparatus (10) under the humidifying operation repeats the first and second operations (described later) each for 3 min 30 sec, alternatively. That is, the humidifying operation is such that a first predetermined period, which is a time period for which the first or second operation is continued, is 3 min 30 sec.

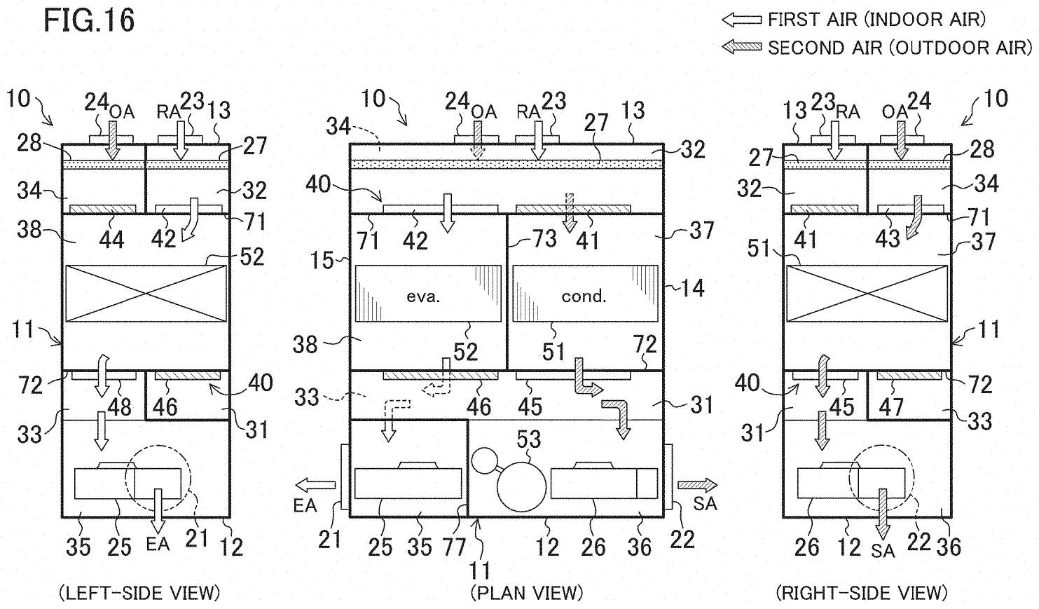

As illustrated in FIG. 16, the first operation of the humidifying operation is such that the switching mechanism (40) switches over the air flow path to the first path. More specifically, the second indoor air damper (42), the first outdoor air damper (43). the first air supply-side damper (45), and the second exhaust-side damper (48) are open, and the first indoor air damper (41), the second outdoor air damper (44), the second air supply-side damper (46), and the first exhaust-side damper (47) are closed. Moreover, in the first operation, the four-way switching valve (54) is in the first state (the state illustrated in FIG. 12A). In this way, the refrigerant circuit (50) performs the refrigeration cycle, in which the first adsorption heat exchanger (51) functions as a condenser (that is, a heat radiator) and the second adsorption heat exchanger (52) functions an evaporator.

The first air flowing into the indoor air path (32) flows into the second heat exchanger compartment (38) via the second indoor air damper (42), and thereafter passes through the second adsorption heat exchanger (52). In the second adsorption heat exchanger (52), the moisture in the first air is adsorbed in the adsorbent, and the adsorption heat generated in the adsorption is absorbed by the refrigerant. The first air thus dehumidified by the second adsorption heat exchanger (52) flows into the exhaust-side path (33) via the second exhaust-side damper (48), and, after passing the exhaust fan compartment (35), is exhausted to the outdoor space (201) via the exhaust port (21).

On the other hand, the second air flowing into the outdoor air path (34) flows into the first heat exchanger compartment (37) via the first outdoor air damper (43), and thereafter passes through the first adsorption heat exchanger (51). In the first adsorption heat exchanger (51), the moisture is desorbed from the adsorbent heated by the refrigerant, and the moisture thus desorbed is added to the second air. Accordingly, the first adsorption heat exchanger (51) increases the temperature of the second air to some extent. The second air thus humidified by the first adsorption heat exchanger (51) flows into the air supply-side path (31) via the first air supply-side damper (45), and, after passing the air supply fan compartment (36), is supplied to the indoor space (200) via the air supply port (22).

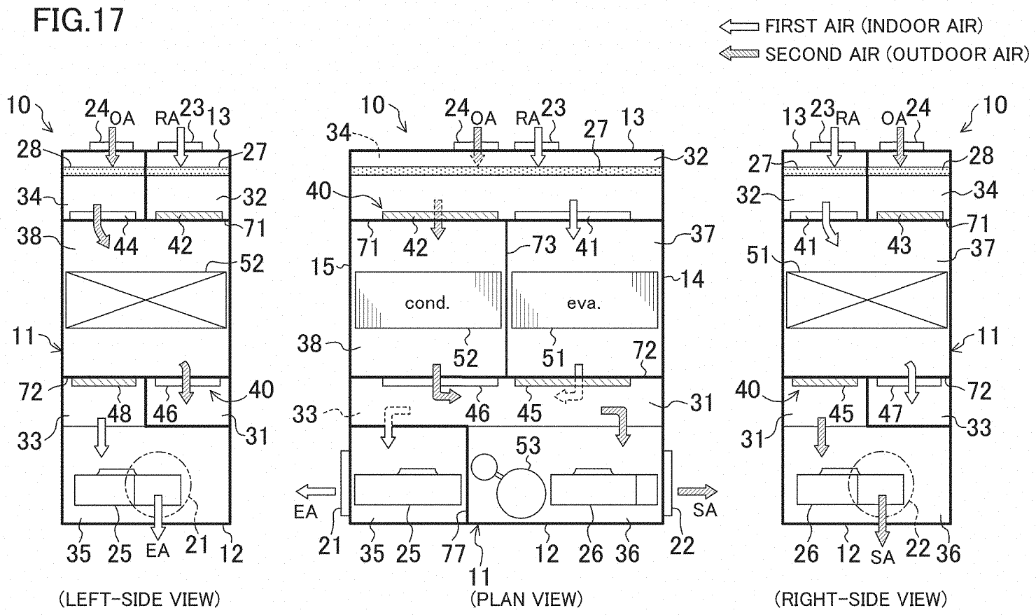

As illustrated in FIG. 17, the second operation of the humidifying operation is such that the switching mechanism (40) switches over the air flow path to the second path. More specifically, the first indoor air damper (41), the second outdoor air damper (44), the second air supply-side damper (46), and the first exhaust-side damper (47) are open, and the second indoor air damper (42), the first outdoor air damper (43). the first air supply-side damper (45), and the second exhaust-side damper (48) are closed. Moreover, in the second operation, the four-way switching valve (54) is in the second state (the state illustrated in FIG. 12B). In this way, the refrigerant circuit (50) performs the refrigeration cycle, in which the second adsorption heat exchanger (52) functions as a condenser (that is, a heat radiator) and the first adsorption heat exchanger (51) functions an evaporator.

The first air flowing into the indoor air path (32) flows into the first heat exchanger compartment (37) via the first indoor air damper (41). and thereafter passes through the first adsorption heat exchanger (51). In the first adsorption heat exchanger (51), the moisture in the first air is adsorbed in the adsorbent, and the adsorption heat generated in the adsorption is absorbed by the refrigerant. The first air thus dehumidified by the first adsorption heat exchanger (51) flows into the exhaust-side path (33) via the first exhaust-side damper (47), and, after passing the exhaust fan compartment (35), is exhausted to the outdoor space (201) via the exhaust port (21).

On the other hand, the second air flowing into the outdoor air path (34) flows into the second heat exchanger compartment (38) via the second outdoor air damper (44), and thereafter passes through the second adsorption heat exchanger (52). In the second adsorption heat exchanger (52), the moisture is desorbed from the adsorbent heated by the refrigerant, and the moisture thus desorbed is added to the second air, Accordingly, the second adsorption heat exchanger (52) increases the temperature of the second air to sonic extent. The second air thus humidified by the second adsorption heat exchanger (52) flows into the air supply-side path (31) via the second air supply-side damper (46), and, after passing the air supply fan compartment (36), is supplied to the indoor space (200) via the air supply port (22).

### Advantages of Second Embodiment

The second embodiment as described above can prove advantages similar to those of the first embodiment by employing, as the adsorbent held on the first adsorption heat exchanger (51) serving as the “first adsorption/desorption portion” and the second adsorption heat exchanger (52) serving as the “second adsorption/desorption portion”, an adsorbent similar to that in the first embodiment.

### Other Embodiments

Even though the embodiments described above (including variations thereof (the same applies hereinafter)) have described the case where the target substance targeted for the adsorption and desorption is water (moisture) as examples, the present disclosure is not limited to this, and the target substance may be, for example, carbon dioxide, an odorous substance (sulfur, ammonia, or the like).

Moreover, even though the embodiments employ the flexible MOF (metal organic framework) being structurally flexible as the adsorbent, but the present embodiment is not limited to this, and the adsorbent may be another material, which converts, into a structural transition energy, the adsorption and desorption thermal energies generated along the adsorption or desorption of the target substance. As an alternative, an another substance, which accumulates an energy in adsorbing the target substance and release, in desorbing the target substance, at least part of the energy accumulated.

Moreover, even though the first embodiment is configured such that the cooling portion (128) and the heating portion (126) are provided upstream of the adsorption/desorption portion (122), the cooling portion (128) or the heating portion (126) may be omitted, depending on climates, seasons, or the like under which the present disclosure is applied.

Moreover, even though the first embodiment is configured such that the substrate of the rotation rotor (122) is in a honey-comb shape, but the present disclosure is not limited to this and the substrate may have a mesh-like shape or a filter-like shape. Again in such a case, the rotation rotor (122) is configured to enable passage of air therethrough in the thickness direction. Moreover, even though the first embodiment is configured such that the rotation rotor (122) is in a disc-like shape, but the present disclosure is not limited to this and the rotation rotor (122) may have a polygon plate-like shape.

Furthermore, the first embodiment is configured to perform the indoor humidification in which the air sucked in from the outdoors is subjected to the adsorption of the moisture to the adsorbent therefrom and is then exhausted outdoors, and the air sucked in from the outdoors is subjected to the desorption of the moisture from the adsorbent and is then exhausted indoors, Furthermore, one variation of the first embodiment is configured to perform the indoor dehumidification in which the air sucked in from the indoors is subjected to the adsorption of the moisture to the adsorbent therefrom and is then exhausted indoors, and the air taken in from the indoors is subjected to the desorption of the moisture from the adsorbent and is then exhausted outdoors. Moreover, the second embodiment is configured to perform the indoor dehumidification in which the air sucked in from the outdoors is subjected to the adsorption of the moisture to the adsorbent therefrom and is then exhausted indoors, and the air taken in from the indoors is subjected to the desorption of the moisture from the adsorbent and is then exhausted outdoors. Furthermore, the second embodiment is configured to perform the indoor humidification in which the air sucked in from the indoors is subjected to adsorption of the moisture to the adsorbent therefrom and is then exhausted outdoors, and the air sucked in from the outdoors is subjected to the desorption of the moisture from the adsorbent and is then exhausted indoors.

Apart from the embodiments as above, an air quality adjustment system may be configured as in (1) to (5) below, for example, with an adsorption/desorption portion similar to those in the embodiments.

(1) The air sucked in from the outdoors is subjected to adsorption of the moisture to the adsorbent and then exhausted outdoors, and the air sucked in from the indoors is subjected to the desorption of the moisture from the adsorbent and is then exhausted indoors. This configuration makes it possible to realize, for example, a waterless humidifier.

(2) The air sucked in from the outdoors is subjected to the adsorption of the moisture to the adsorbent and is then exhausted indoors, and the air taken in from the outdoors is subjected to the desorption of the moisture from the adsorbent and is then exhausted indoors. This configuration makes it possible to supply the outdoor air of, for example, two different types such as “dry air” and “wet air” into the indoors.

(3) The air sucked in from the indoors is subjected to the adsorption of the moisture to the adsorbent and is then exhausted outdoors, and the air sucked in from the indoors is subjected to the desorption of the moisture from the adsorbent and is then exhausted indoors. This configuration makes it possible to realize, for example, a room dryer for humidification.

(4) The air sucked in from the indoors is subjected to the adsorption of the moisture to the adsorbent and is then exhausted indoors, and the air sucked in from the outdoors is subjected to the desorption of the moisture from the adsorbent and is then exhausted outdoors. This configuration makes it possible to realize, for example, a dehumidifier without a need of water disposal, or a carbon dioxide absorbing device without the need of ventilation.

(5) The air sucked in from the indoors is subjected to adsorption of the moisture to the adsorbent and is then exhausted indoors, and the air taken in from the indoors is subjected to the desorption of the moisture from the adsorbent and is then exhausted indoors. This configuration makes it possible to supply the indoor air of, for example, two different types such as “dry air” and “wet air” into the indoors.

While the embodiments and variations have been described above, it will be understood that various changes in form and details can be made without departing from the spirit and scope of the claims. The above embodiments and variations may be appropriately combined or replaced as long as the functions of the target of the present disclosure are not impaired.

As described above, the present disclosure is applicable to an air quality adjustment system.

1. An air quality adjustment system, comprising:
an adsorption-desorption portion configured to adsorb a target substance in air and desorb the target substance adsorbed by the adsorption-desorption portion,
the adsorption-desorption portion being configured to
accumulate an energy in adsorbing the target substance and
release, in desorbing the target substance, at least part of the energy accumulated.

2. An air quality adjustment system, comprising:
an adsorption-desorption portion including
an adsorption region configured to adsorb a target substance in air and
a desorption region configured to desorb the target substance adsorbed to the adsorption-desorption portion; and
a cooling portion provided upstream of the adsorption region, the cooling portion being configured to cool the air before the air flows into the adsorption region,
the adsorption-desorption portion being configured to adsorb the target substance at a temperature higher than an isenthalpic curve of an air state which is obtained by excluding, from an air state of the air flowing out from the adsorption region,
a residual energy remaining in the target substance after the adsorption to the adsorption region,
a friction heat of the air in the adsorption-desorption portion, and
a heat balance due to a heat capacity of the adsorption-desorption portion.

3. The air quality adjustment system of claim 2. further comprising:
a heating portion provided upstream of the desorption region, the heating portion being configured to heat the air before the air flows into the desorption region,
the adsorption-desorption portion being configured to desorb the target substance at a temperature lower than an isenthalpic curve of an air state which is obtained by excluding, from an air state of the air flowing out from the desorption region,
a residual energy remaining in the target substance after the desorption from the desorption region,
the friction heat of the air in the adsorption-desorption portion, and
a heat balance due to the heat capacity of the adsorption-desorption portion.

4. An air quality adjustment system, comprising:
an adsorption-desorption portion including
an adsorption region configured to adsorb a target substance in air and to a desorption region configured to desorb the target substance adsorbed to the adsorption-desorption portion; and
a heating portion provided upstream of the desorption region, the heating portion being configured to heat the air before the air flows into the desorption region,
the adsorption-desorption portion being configured to desorb the target substance at a temperature lower than an isenthalpic curve of an air state which is obtained by excluding, from an air state of the air flowing out from the desorption region,
a residual energy remaining in the target substance after the desorption from the desorption region,
a friction heat of the air in the adsorption-desorption portion, and
a heat balance due to the heat capacity of the adsorption-desorption portion,

5. An air quality adjustment system, comprising:
an adsorption-desorption portion configured to adsorb a target substance in air and desorb the target substance adsorbed to the adsorption-desorption portion; and
an adjustment portion configured to adjust a temperature of the adsorption-desorption portion,
for the adsorption of the target substance, the adjustment portion being configured to deprive from the adsorption-desorption portion an energy amount smaller than an energy difference of the air between before and after passing the adsorption-desorption portion, and
for the desorption of the target substance, the adjustment portion being configured to provide the energy amount to the adsorption-desorption portion, in terms of the energy balance from which a residual energy remaining in the target substance after the adsorption to or desorption from the adsorption-desorption portion, a friction heat of the air in the adsorption-desorption portion, and a heat balance due to a heat capacity of the adsorption-desorption portion are excluded.

6. The air quality adjustment system of claim 1, wherein
the adsorption-desorption portion is made from a material, which converts, into a structural transition energy, adsorption and desorption thermal energies generated due to the adsorption or desorption of the target substance.

7. The air quality adjustment system of claim 6, wherein
the material is a metal organic framework that is structurally flexible.

8. The air quality adjustment system of claim 2, wherein
the adsorption-desorption portion is made from a material, which converts, into a structural transition energy, adsorption and desorption thermal energies generated due to the adsorption or desorption of the target substance.

9. The air quality adjustment system of claim 8, wherein
the material is a metal organic framework that is structurally flexible.

10. The air quality adjustment system of claim 3, wherein
the adsorption-desorption portion is made from a material, which converts, into a structural transition energy, adsorption and desorption thermal energies generated due to the adsorption or desorption of the target substance.

11. The air quality adjustment system of claim 10, wherein
the material is a metal organic framework that is structurally flexible.

12. The air quality adjustment system of claim 4, wherein
the adsorption-desorption portion is made from a material, which converts, into a structural transition energy, adsorption and desorption thermal energies generated due to the adsorption or desorption of the target substance.

13. The air quality adjustment system of claim 12, wherein
the material is a metal organic framework that is structurally flexible.

14. The air quality adjustment system of claim 5, wherein
the adsorption-desorption portion is made from a material, which converts, into a structural transition energy, adsorption and desorption thermal energies generated due to the adsorption or desorption of the target substance.

15. The air quality adjustment system of claim 14, wherein
the material is a metal organic framework that is structurally flexible.
